(19) United States
(12) Patent Application Publication
(10) Pub. No.: US 2010/0088899 A1
(43) Pub. Date: Apr. 15, 2010

(54) Carabiner with folding utility knife

(76) Inventors: Michael Garcia, Oakland Park, FL (US); Joseph Deguglimo, Boca Raton, FL (US)

Correspondence Address: Dan M. De La Rosa;Suite 24C, 300 East 77th Street, New York, NY, 10075, US

(21) Appl. No.: 12/587,588

(22) Filed: Oct. 9, 2009

Related U.S. Application Data
(60) Provisional application No. 61/195,941, filed on Oct. 14, 2008.

(51) Int. Cl. B26B 11/00; B26B 1/04

(52) U.S. Cl. 30/123; 30/161

(57) ABSTRACT

A carabiner with a folding utility knife is provided, and the carabiner comprises: a handle element with two opposing first and second ends, the handle element has a cavity; a gate element for connecting the first and second ends of the handle element to form a handle element aperture, the gate element has opposing ends, at least one end of the gate element is pivotally attached to at least one end of the handle element, the gate element is movable to a closed position and an opened position; a blade; and a blade holder compartment having a front end and rear end, the rear end of the blade holder compartment is pivotally attached to at least a portion of the handle, the blade holder compartment comprises a cavity for receiving the blade, and the front end of the blade holder compartment has an aperture for allowing a portion of the blade to protrude from the aperture, and the blade holder compartment is movable to a closed position and an opened position.

### RELATED APPLICATION

This application is related to U.S. Provisional Application Ser. No. 61/195,941 entitled “Carabiner With Folding Utility Knife” which was filed on Oct. 14, 2008.

### BACKGROUND OF THE INVENTION

1. Field of the Invention

This invention relates to a carabiner apparatus with folding utility knife, the apparatus comprising: a handle element with two opposing first and second ends, the handle element has a cavity; a gate element for connecting the first and second ends of the handle element to form a handle element aperture, the gate element has opposing ends, at least one end of the gate element is pivotally attached to at least one end of the handle element; a blade, and; a blade holder compartment having a front end and rear end, the rear end of the blade holder compartment is pivotally attached to at least a portion of the handle, the blade holder compartment comprises a cavity for receiving the blade, and the front end of the blade holder compartment has an aperture for allowing a portion of the blade to protrude from the aperture.

2. Description of the Related Art

There are various patents covering folding utility knife type devices. There are a few patents that relate to carabiners with folding knives. The present invention provides for a carabiner with a folding utility knife.

### SUMMARY OF THE INVENTION

In one embodiment, the present invention provides for a carabiner apparatus with folding utility knife, the apparatus comprises: a carabiner body comprising a handle element with two opposing first and second ends, the handle element has a cavity; a gate element having opposing ends, the first end of the gate element is pivotally attached to the first end of the handle element, the gate element is movable to a first closed position wherein the second end of the gate element is in contact with the second end of the handle element, the gate element is movable to a second opened position wherein the second end of the gate element is moved away from the second end of the handle element; and a blade holder compartment having a front end and rear end, the rear end of the blade holder compartment is pivotally attached to at least a portion of the handle, the blade holder compartment is movable to a first closed position wherein at least a portion of the blade holder compartment is situated within the cavity of the handle element, the blade holder compartment is movable to a second opened position wherein the blade holder compartment is moved away from the cavity of the handle element.

In another embodiment, the apparatus further comprises a blade, and the blade holder compartment comprises a cavity for receiving the blade, the front end of the blade holder compartment has an aperture for allowing a portion of the blade to protrude from the aperture.

In yet another embodiment, the apparatus further comprises a folding mechanism for moving the blade holder compartment from the closed position to the open position and back to the closed position. In still another embodiment, the folding mechanism comprises a movable pin situated within the cavity of the handle element and a button situated on an external surface of the handle element for moving the pin, and the blade holder compartment has an indentation, and the pin engages the indentation of the blade holder compartment during a locked position, and the pin disengaging from the indentation to release the blade holder compartment during an unlocked position.

In still yet another embodiment, the apparatus further comprises a blade release mechanism.

In a further embodiment, the apparatus further comprises a locking mechanism for locking the second end of the gate element is secured to the second end of the handle element. In another further embodiment, the locking mechanism comprises a twist lock device.

In yet a further embodiment, the handle element and the gate element forms an aperture during the closed position. In still a further embodiment, the handle element comprises a front end and a rear end, and the rear end forms the aperture with the gate element. In still a further embodiment, the front end of the handle element comprises at least three indentations which forms grips for user's fingers.

In still yet a further embodiment, the handle element further comprises a second cavity. In another embodiment, the apparatus further comprises at least one movable tool, and the tool is pivotally attached adjacent to the second cavity of the handle element. In yet another embodiment, at least a portion of the tool is situated within the second cavity during a stowage position and the tool is moved away from the second cavity during a usage position.

In still another embodiment, the present invention provides for a carabiner with a folding utility knife, and the carabiner comprises: a handle element with two opposing first and second ends, the handle element has a cavity; a gate element for connecting the first and second ends of the handle element to form a handle element aperture, the gate element has opposing ends, at least one end of the gate element is pivotally attached to at least one end of the handle element, the gate element is movable to a closed position and an opened position; a blade; and a blade holder compartment having a front end and rear end, the rear end of the blade holder compartment is pivotally attached to at least a portion of the handle, the blade holder compartment comprises a cavity for receiving the blade, and the front end of the blade holder compartment has an aperture for allowing a portion of the blade to protrude from the aperture, and the blade holder compartment is movable to a closed position and an opened position.

In still another embodiment, the apparatus further comprises a folding mechanism for moving the blade holder compartment from the closed position to the open position and back to the closed position. In still yet another embodiment, the apparatus further comprises a blade release mechanism. In another embodiment, the apparatus further comprises a locking mechanism for securing the gate element to the handle element.

In a further embodiment, the handle element further comprises a second cavity. In yet a further embodiment, the apparatus further comprises at least one movable tool, and the tool is pivotally attached adjacent to the second cavity of the handle element.

In another further embodiment, the present invention relates to a carabiner apparatus with folding utility knife, the apparatus comprising: a handle element with two opposing first and second ends, the handle element has a cavity; a gate element for connecting the first and second ends of the handle element to form a handle element aperture, the gate element has opposing ends, at least one end of the gate element is pivotally attached to at least one end of the handle element; a blade; a blade holder compartment having a front end and rear end, the rear end of the blade holder compartment is pivotally attached to at least a portion of the handle, the blade holder compartment comprises a cavity for receiving the blade, and the front end of the blade holder compartment has an aperture for allowing a portion of the blade to protrude from the aperture; a blade release mechanism; and blade holder compartment folding mechanism.

In a further embodiment, the handle element comprises two pieces or two halves and the two pieces form the cavity within which the blade holder compartment is situated during the closed position.

In another embodiment, the blade holder compartment comprises a sliding mechanism wherein the compartment is slideably moved with the cavity of the handle element during a closed position and then the compartment is slideably moved outside of the cavity of the handle element during the opened position. In a further embodiment, the handle element and/or the blade holder compartment are provided with tracks or apertures with pins that allow for the sliding mechanism.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is perspective views of the carabiner of the present invention with the folding blade holding compartment in an open position;

FIG. 2 is perspective views of the carabiner of FIG. 1 in a closed position;

FIG. 3 is a side view of the carabiner showing the folding mechanism;

FIG. 4 is a perspective view of FIG. 1 showing the removal of the blade from the blade holding compartment;

FIG. 5 is a perspective view of FIG. 1 showing the pivoting tools; and

FIG. 6 is a perspective view of FIG. 1 showing the gate element in an open position.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

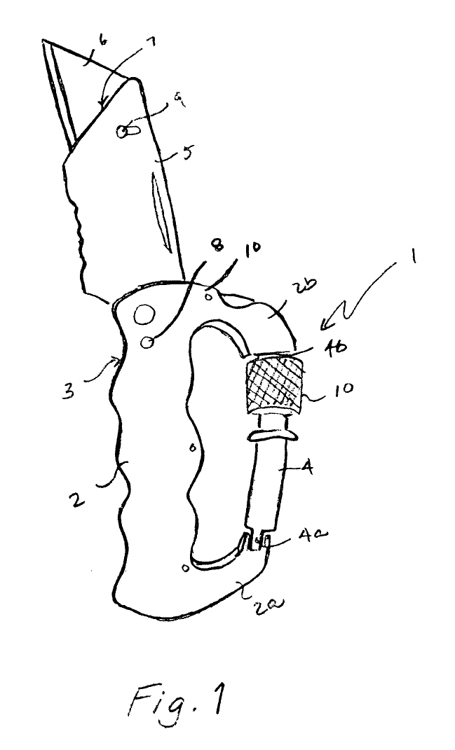

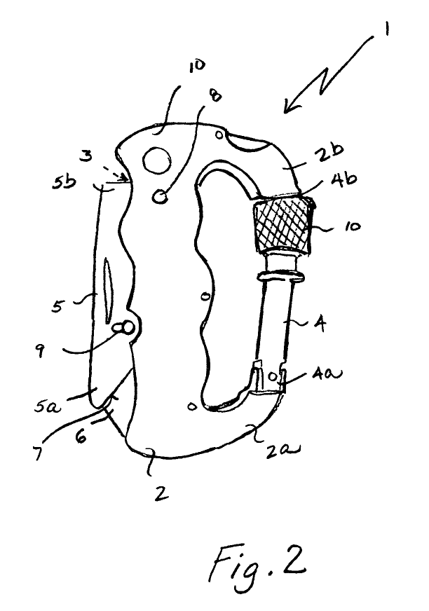

FIGS. 1-2 illustrate an apparatus 1 comprises: a carabiner body 10 comprising a handle element 2 with two opposing first and second ends, 2a and 2b respectively. The handle element 2 has a cavity 3. The apparatus 1 further comprises a gate element 4 having opposing ends, 4a and b respectively, and the first end 4a of the gate element is pivotally attached to the first end 2a of the handle element 2. The gate element 4 is movable to a first closed position wherein the second end 4b of the gate element 4 is in contact with the second end 2b of the handle element 2. The gate element 4 is movable to a second opened position wherein the second end 4b of the gate element 4 is moved away from the second end 2b of the handle element 2. The apparatus 1 also comprises a blade holder compartment 5 having a front end 5a and rear end 5b; the rear end 5b of the blade holder compartment 5 is pivotally attached to at least a portion of the handle element 2. The blade holder compartment 5 is movable to a first closed position wherein at least a portion of the blade holder compartment 5 is situated within the cavity 3 of the handle element 2, and the blade holder compartment 5 is movable to a second opened position wherein the blade holder compartment 5 is moved away from the cavity 3 of the handle element 2.

The apparatus 1 further comprises a blade 6, and the blade holder compartment 5 comprises a cavity (not shown) for receiving the blade 6. The front end 5a of the blade holder compartment 5 has an aperture 7 for allowing a portion of the blade 6 to protrude from the aperture 7.

The apparatus further comprises a blade release mechanism 9. The apparatus further comprises a locking mechanism 10 for locking the second end of the gate element is secured to the second end of the handle element.

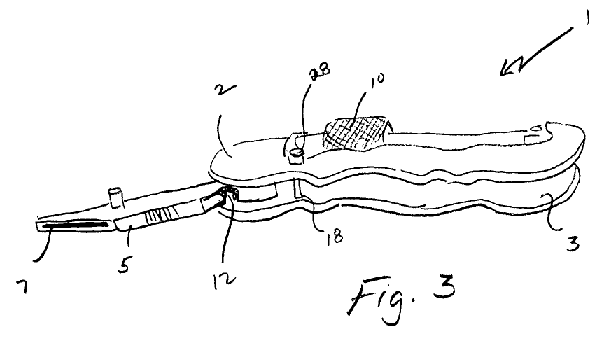

Referring now to FIG. 3, the apparatus 1 further comprises a folding mechanism 8 for moving the blade holder compartment 5 from the closed position to the open position and back to the closed position. The folding mechanism 8 comprises a movable pin 18 situated within the cavity 3 of the handle element 2 and a button 28 situated on an external surface of the handle element 2 for moving the pin 18, and the blade holder compartment 2 has an indentation 12, and the pin 18 engages the indentation 12 of the blade holder compartment 5 during a locked position, and the pin 18 disengaging from the indentation 12 to release the blade holder compartment 2 during an unlocked position.

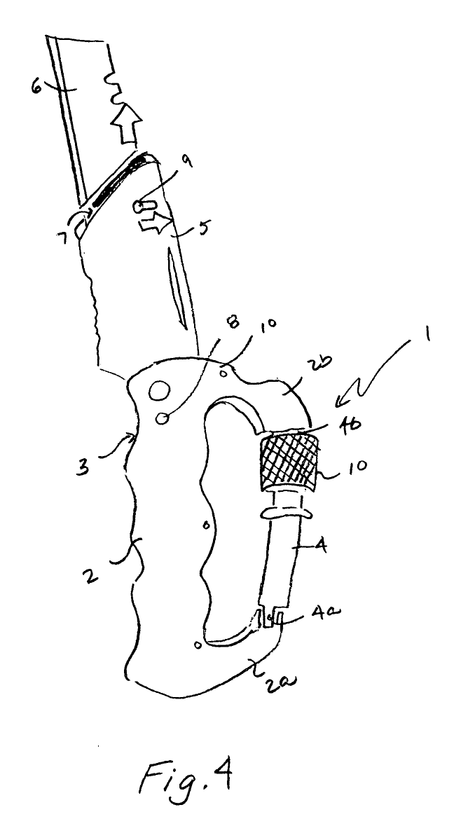

Referring now to FIG. 4, the apparatus 1 further comprises a blade release mechanism 9. The present invention can use any mechanism that secures the blade 6 within the cavity of the blade holder compartment 5 and then releases the blade 6. In one embodiment, the blade release mechanism 9 is a button that releases the support prongs which are situated on the two indentations of the blade 6.

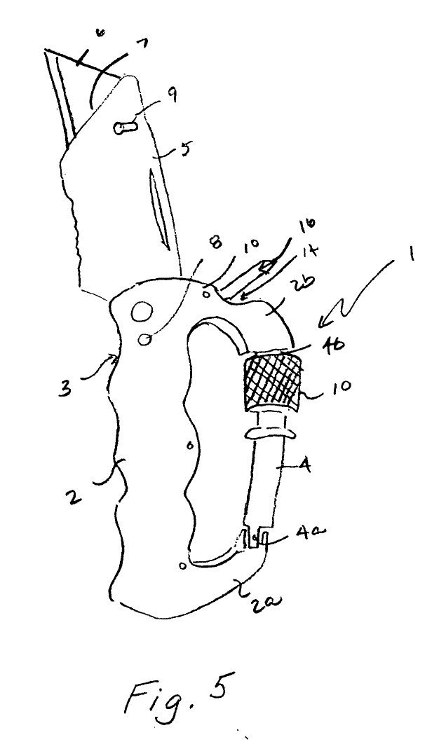

Referring now to FIG. 5, the handle element 2 further comprises a second cavity 14. The apparatus 1 further comprises at least one movable tool 16, and the tool 16 is pivotally attached adjacent to the second cavity 14 of the handle element 2. At least a portion of the tool 16 is situated within the second cavity 14 during a stowage position and the tool 16 is moved away from the second cavity 14 during a usage position.

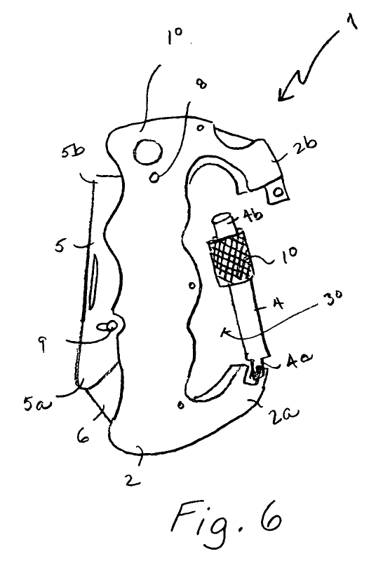

Referring now to FIG. 6, the apparatus 1 further comprises a locking mechanism 10 for locking the second end 4b of the gate element 4 is secured to the second end 2b of the handle element 2. The handle element 2 and the gate element 4 form an aperture 30 during the closed position. The handle element 2 comprises a front end 2c and a rear end 2d, and the rear end 2d forms the aperture 30 with the gate element 4. The front end 2c of the handle element 2 comprises at least three indentations 33 which forms grips for user's fingers.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A carabiner apparatus with folding utility knife, said apparatus comprising:
a carabiner body comprising a handle element with two opposing first and second ends, said handle element having a cavity;
a gate element having opposing ends, said first end of said gate element being pivotally attached to said first end of said handle element, said gate element being movable to a first closed position wherein said second end of said gate element is in contact with said second end of said handle element, said gate element being movable to a second opened position wherein said second end of said gate element is moved away from said second end of said handle element; and
a blade holder compartment having a front end and rear end, said rear end of said blade holder compartment being pivotally attached to at least a portion of said handle element, said blade holder compartment is movable to a first closed position wherein at least a portion of said blade holder compartment is situated within said cavity of said handle element, said blade holder compartment is movable to a second opened position wherein said blade holder compartment is moved away from said cavity of said handle element.

2. The apparatus of claim 1 further comprising a blade, said blade holder compartment comprises a cavity for receiving said blade, said front end of said blade holder compartment having an aperture for allowing a portion of said blade to protrude from said aperture.

3. The apparatus of claim 1 further comprising a folding mechanism for moving said blade holder compartment from said closed position to said open position and back to said closed position.

4. The apparatus of claim 3 wherein said folding mechanism comprises a movable pin situated within said cavity of said handle element and a button situated on an external surface of said handle element for moving said pin, said blade holder compartment having an indentation, said pin engaging said indentation of said blade holder compartment during a locked position, said pin disengaging from said indentation to release said blade holder compartment during an unlocked position.

5. The apparatus of claim 2 further comprising a blade release mechanism.

6. The apparatus of claim 1 further comprising a locking mechanism for locking said second end of said gate element is secured to said second end of said handle element.

7. The apparatus of claim 1 wherein said handle element and said gate element during said closed position forms an aperture.

8. The apparatus of claim 7 wherein said handle element comprises a front end and a rear end, said rear end forming said aperture with said gate element.

9. The apparatus of claim 8 wherein said front end of said handle element comprises at least three indentations which forms grips for user's fingers.

10. The apparatus of claim 1 wherein said handle element further comprises a second cavity.

11. The apparatus of claim 10 further comprising at least one movable tool, said tool being pivotally attached adjacent to said second cavity of said handle element.

12. The apparatus of claim 11 wherein at least a portion of said tool is situated within said second cavity during a stowage position and said tool being moved away from said second cavity during a usage position.

13. The apparatus of claim 6 wherein said locking mechanism comprises a twist lock device.

14. A carabiner apparatus with folding utility knife, said apparatus comprising:
a handle element with two opposing first and second ends, said handle element having a cavity;
a gate element for connecting said first and second ends of said handle element to form a handle element aperture, said gate element having opposing ends, at least one end of said gate element being pivotally attached to at least one end of said handle element, said gate element being movable to a closed position and an opened position;
a blade; and
a blade holder compartment having a front end and rear end, said rear end of said blade holder compartment being pivotally attached to at least a portion of said handle, said blade holder compartment comprises a cavity for receiving said blade, said front end of said blade holder compartment having an aperture for allowing a portion of said blade to protrude from said aperture, said blade holder compartment is movable to a closed position and an opened position.

15. The apparatus of claim 14 further comprising a folding mechanism for moving said blade holder compartment from said closed position to said open position and back to said closed position.

16. The apparatus of claim 14 further comprising a blade release mechanism.

17. The apparatus of claim 14 further comprising a locking mechanism for securing said gate element to said handle element.

18. The apparatus of claim 14 wherein said handle element further comprises a second cavity.

19. The apparatus of claim 18 further comprising at least one movable tool, said tool being pivotally attached adjacent to said second cavity of said handle element

20. A carabiner apparatus with folding utility knife, said apparatus comprising:
a handle element with two opposing first and second ends, said handle element having a cavity;
a gate element for connecting said first and second ends of said handle element to form a handle element aperture, said gate element having opposing ends, at least one end of said gate element being pivotally attached to at least one end of said handle element;
a blade;
a blade holder compartment having a front end and rear end, said rear end of said blade holder compartment being pivotally attached to at least a portion of said handle, said blade holder compartment comprises a cavity for receiving said blade, said front end of said blade holder compartment having an aperture for allowing a portion of said blade to protrude from said aperture;
a blade release mechanism; and blade holder compartment folding mechanism.
